(19) United States
(12) Patent Application Publication
(10) Pub. No.: US 2011/0069597 A1
(43) Pub. Date: Mar. 24, 2011

(54) OPTICAL HEAD APPARATUS, HOLOGRAPHIC OPTICAL DEVICE, OPTICAL INTEGRATED DEVICE, OPTICAL INFORMATION PROCESSING APPARATUS, AND SIGNAL DETECTION METHOD

(75) Inventors: Hiroaki Yamamoto, Hyogo (JP); Jun-iti Asada, Hyogo (JP)

(73) Assignee: Panasonic Corporation, Osaka (JP)

(21) Appl. No.: 12/935,398

(22) PCT Filed: Mar. 18, 2010
(86) PCT No.: PCT/JP2010/001929

§ 371 Date: Sep. 29, 2010

(30) Foreign Application Priority Data
May 15, 2009 (JP) 2009-119312

(51) Int. Cl. G11B 7/00; G02B 5/32

(52) U.S. Cl. 369/103; 359/15; G9B/7

(57) ABSTRACT

An optical head apparatus including a holographic optical device which diffracts a light beam and includes a first diffraction region and a second diffraction region facing each other across a region dividing line passing through an optical axis of a light-collection optical system and extending in a radial direction of an optical disc, the first diffraction region having a grating pattern for generating diffracted light having a first wavefront and entering a first photoreception region and a second photoreception region, the second diffraction region having a grating pattern for generating diffracted light having a second wavefront and entering a third photoreception region and a fourth photoreception region, the first and second wavefronts having first and second coma aberrations in the radial direction of the optical disc, respectively, and the first and second coma aberrations having axes located off the optical axis.

### TECHNICAL FIELD

The present invention relates to an optical head apparatus, a holographic optical device, an optical integrated device, an optical information processing apparatus, and a signal detection method for recording, reproducing or deleting information stored on an optical medium such as an optical disc or an optical card.

### BACKGROUND ART

In recording optical information on optical discs and so on, the servo technology is essential for collecting light to an optical spot at a desired recording and reproducing position. To detect a tracking error signal with the servo technology, it is common to switch among multiple methods according to the type of media on and from which recording and reproducing are to be performed. Therefore, optical head apparatuses are required to detect multiple tracking error signals. For example, optical head apparatuses for DVDs are required to detect a differential phase detection tracking signal (DPD signal) in the case of a reproduction-only DVD-ROM, and a push-pull signal (PP signal) in the case of a recording optical disc represented by DVD-RAMs.

Likewise, the Blu-ray system also requires optical head apparatuses capable of detecting the DPD signal and the PP signal.

This has led to the proposal of various conventional techniques for detecting the DPD signal and the PP signal (for example, see Patent Literature 1).

### CITATION LIST

### Patent Literature

### [PTL 1]

Japanese Unexamined Patent Application Publication No. 2001-229573

### [PTL 2]

Japanese Patent Application No. 2008-168479

### SUMMARY OF INVENTION

### Technical Problem

Holographic optical devices (also known as holographic optical elements (HOEs)) are widely used for such detection systems since they allow simplification of signal detection optical systems and thus enable implementation of optical head apparatuses that are small in size, low in cost, and high in stability.

As an optical head apparatus which includes an HOE capable of detecting the DPD signal and the PP signal, there is an optical head apparatus disclosed in Patent Reference 2. Hereinafter, the optical head apparatus according to Patent Literature 2 is described. Note that although Patent Reference 2 describes a differential push-pull method (DPP method) which is an extension of a push-pull method, the following describes only the push-pull method for simplicity.

FIG. 10 is a diagram showing a structure of the optical head apparatus according to Patent Literature 2.

FIG. 10 shows a semiconductor laser device 30, a photoreceptor 40, a holographic optical device 20, and others. The semiconductor laser device 30 and the photoreceptor 40 are provided close to each other and fixed to a holding unit 741. The holding unit 741 is fixed with the holographic optical device 20 with a desired positional relationship via another holding unit (not shown). Note that although the other holding unit may be an optical bench of the optical head apparatus, a unit may be provided into which the holographic optical device 20, the semiconductor laser device 30, and the photoreceptor 40 are integrated using a holding member different from the optical bench. Such a unit structure allows the optical system to be stably structured.

The optical head apparatus further includes a collimating lens 11 and an object lens 12 that make up a light-collection optical system for collecting laser light on an optical disc 10 that is an information recording medium. In addition, the optical head apparatus includes a lens driving mechanism (not shown) that displaces the object lens 12 in the optical-axis direction of the object lens 12 (z direction) and in the radial direction of the optical disc 10 (x direction).

Hereinafter, unless otherwise noted, the optical-axis direction of the light-collection optical system is referred to as Z-axis direction, the radius direction of the optical disc 10 (radial direction) is referred to as X direction, and the track direction of the optical disc 10 (tangential direction) is referred to as Y direction as indicated in FIG. 10. Note that even in the case where the optical axis is bent by a mirror, a prism, or the like, the directions of the optical system of the optical head apparatus are defined with reference to the optical axis and a map of the optical disc 10.

A light beam R0 emitted from the semiconductor laser device 30 passes through the holographic optical device 20 and is collected on the information recording surface of the optical disc 10 by the collimating lens 11 and the object lens 12. The light reflected from the optical disc 10 is converted by the object lens 12 and the collimating lens 11 into light converging at the light emission point of the semiconductor laser device 30. This light enters the holographic optical device 20 and is diffracted. The diffracted light enters the photoreceptor 40, and the photoreceptor 40 detects signals from the diffracted light.

FIG. 11 is a diagram showing diffraction regions of the holographic optical device 20 included in the optical head apparatus according to Patent Literature 2.

The grating pattern of the holographic optical device 20 is that it is divided into a first diffraction region 261 and a second diffraction region 262 by a straight line L11 parallel to the X axis and passing through the approximate center of the light beam. R0 in FIG. 11 is the light reflected from the optical disc 10 and entering the holographic optical device 20. R1 and R2 are light diffracted by the optical disc 10, and produce a contrast corresponding to a tracking position in regions interfering with R0, that is, overlapping regions.

FIG. 12 is a diagram showing photoreception regions of the photoreceptor 40 included in the optical head apparatus according to Patent Literature 2. The photoreceptor 40 has a first photoreception region group 451 and a second photoreception region group 452. The first photoreception region group 451 includes a first photoreception region 451a and a second photoreception region 451b facing each other across a first photoreception dividing line L71 which is approximately parallel to the X axis, whereas the second photoreception region group 452 includes a third photoreception region 452a and a fourth photoreception region 452b facing each other across a second photoreception dividing line L72 which is approximately parallel to the X axis.

The first diffraction region 261 has a grating pattern that converts light returning from the optical disc 10 into light entering the first photoreception region 451a and the second photoreception region 451b with a first coma aberration in the X direction across the first photoreception dividing line L71 of the first photoreception region group 451.

The second diffraction region 262 has a grating pattern that converts light returning from the optical disc 10 into light entering the third photoreception region 452a and the fourth photoreception region 452b with a second coma aberration which is formed across the second photoreception dividing line L72 of the second photoreception region group 452 and is opposite in polarity to the first coma aberration caused by the grating pattern of the first diffraction region 261.

Here, the following assumptions are applied: a signal detected in the first photoreception region 451a is a first signal S1; a signal detected in the second photoreception region 451b is a second signal S2; a signal detected in the third photoreception region 452a is a third signal S3; a signal detected in the fourth photoreception region 452b is a fourth signal S4; a sum of the first signal S1 and the fourth signal S4 is (S1+S4); a sum of the second signal S2 and the third signal S3 is (S2+S3); a sum of the first signal S1 and the third signal S3 is (S1+S3); and a sum of the second signal S2 and the fourth signal S4 is (S2+S4). With such assumptions, a focus error (FE) signal in this structure is detected according to the equation below. Note that what is calculated according to the equation is the level (intensity) of a signal. (The same holds true for the other equations.)

FE=(S1+S4)−(S2+S3) (Equation 1)

A tracking error signal TE_{DPD} according to the DPD method and a tracking error signal TE_{PP} according to the push-pull method are generated by calculation according to the equations below.

TE_{PP}=(S1+S3)−(S2+S4) (Equation 2)

TE_{DPD}=Phase (S1+S4, S2+S3) (Equation 3)

Here, phase is a function for phase comparison (calculation of phase difference) between two signals.

However, the TE signal of the optical head apparatus according to Patent Literature 2 has a problem of being susceptible to assembly errors such as an error in adjusting the photoreceptor 40. The details are described hereinafter using parts (a) and (b) of FIG. 13.

The part (a) in FIG. 13 shows an ideal state, whereas the part (b) in FIG. 13 shows photoreception regions of the photoreceptor 40 in a state where the photoreceptor 40 is shifted in the tangential direction (Y direction).

In the ideal state ((a) in FIG. 13), the light beams R1 and R2 generating the push-pull signal enter in such a manner as shown. In this case, the boundary line between the light beams R1 and R2 coincides with the first photoreception dividing line L71 and the second photoreception dividing line L72, and thus the signals in each of these two regions are detected without leaking into the other region, thereby enabling detection of the push-pull signal without problems.

However, in the case where the photoreceptor 40 is shifted in the tangential direction (Y direction) due to an adjustment error ((b) in FIG. 13), the light beams R2 leak into the regions of the light beams R1 (the second photoreception region 451b and the fourth photoreception region 452b). This causes a decrease in the amplitude of the TE signal TE_{PP} detected according to the push-pull method shown in Equation 2 above. In addition, the TE signal TE_{DPD} detected according to the DPD method shown in Equation 3 above also degrades due to crosstalk.

As described, the tracking error (TE) signals are susceptible to a shift of the photoreceptor 40 in the tangential direction (Y direction). For this reason, a problem arises that the photoreceptor 40 needs to be adjusted with high precision.

Thus, the present invention has been conceived in view of the above problems, and it is an object of the present invention to provide an optical head apparatus, a holographic optical device, an optical integrated device, an optical information processing apparatus, and a signal detection method that enable reduction of the adverse effect of a positional shift of the photoreceptor on tracking signals and enable detection of tracking error signals for more accurate and stable recording and/or reproduction.

### Solution to Problem

In order to achieve the above object, the optical head apparatus according to an aspect of the present invention is an optical head apparatus including: a light source which emits a light beam; a light-collection optical system which receives the light beam and converges the light beam to a minute spot on an information recording medium having tracks; a holographic optical device which diffracts the light beam reflected from the information recording medium; and a photoreceptor which receives the light beam diffracted by the holographic optical device, wherein the photoreceptor includes at least: a first photoreception region in which a first signal S1 is detected; a second photoreception region in which a second signal S2 is detected; a third photoreception region in which a third signal S3 is detected; and a fourth photoreception region in which a fourth signal S4 is detected, the first photoreception region and the second photoreception region face each other across a first photoreception dividing line, the third photoreception region and the fourth photoreception region face each other across a second photoreception dividing line, the holographic optical device includes a first diffraction region and a second diffraction region, the first diffraction region and the second diffraction region face each other across a region dividing line passing through an optical axis of the light-collection optical system and extending in a radial direction of the information recording medium, the first diffraction region has a grating pattern for generating diffracted light having a first wavefront and entering the first and second photoreception regions, the second diffraction region has a grating pattern for generating diffracted light having a second wavefront and entering the third and fourth photoreception regions, the first wavefront has a first coma aberration in the radial direction of the information recording medium, the first coma aberration having an axis located off the optical axis of the light-collection optical system, and the second wavefront has a second coma aberration in the radial direction of the information recording medium, the second coma aberration having an axis located off the optical axis of the light-collection optical system.

With this, the first and second wavefronts have the first and second coma aberrations in the radial direction of the information recording medium, respectively, and the axes of the first and second coma aberrations are located off the optical axis of the light-collection optical system, thereby making it possible to reliably extract tracking signal components even in the case where the position of the photoreceptor is shifted in that direction.

Note that the present invention can be realized not only as the optical head apparatus above, but also as an holographic optical device which functions as a diffraction device that diffracts light, the holographic optical device including a first diffraction region and a second diffraction region facing each other across a region dividing line, wherein the first diffraction region generates diffracted light having a first coma aberration in a direction of the region dividing line, the first coma aberration having an axis located off the region dividing line and the second diffraction region generates diffracted light having a second coma aberration in the direction of the region dividing line, the second coma aberration having an axis located off the region dividing line.

The present invention can be realized also as an optical integrated device including: a light source which emits a light beam; a holographic optical device which diffracts the light beam reflected from an information recording medium; and a photoreceptor which receives the light beam diffracted by the holographic optical device, wherein the photoreceptor includes at least: a first photoreception region in which a first signal S1 is detected; a second photoreception region in which a second signal S2 is detected; a third photoreception region in which a third signal S3 is detected; and a fourth photoreception region in which a fourth signal S4 is detected, the first photoreception region and the second photoreception region face each other across a first photoreception dividing line, the third photoreception region and the fourth photoreception region face each other across a second photoreception dividing line, the holographic optical device includes a first diffraction region and a second diffraction region, the first diffraction region and the second diffraction region face each other across a region dividing line passing through an optical axis of a light-collection optical system and extending in a radial direction of the information recording medium, the first diffraction region has a grating pattern for generating diffracted light having a first wavefront and entering the first and second photoreception regions, the second diffraction region has a grating pattern for generating diffracted light having a second wavefront and entering the third and fourth photoreception regions, the first wavefront has a first coma aberration in the radial direction of the information recording medium, the first coma aberration having an axis located off the optical axis of the light-collection optical system, and the second wavefront has a second coma aberration in the radial direction of the information recording medium, the second coma aberration having an axis located off the optical axis of the light-collection optical system.

The present invention can be realized also as a signal detection method performed by an optical head apparatus, wherein the optical head apparatus includes: a light source which emits a light beam; a light-collection optical system which receives the light beam and converges the light beam to a minute spot on an information recording medium having tracks; a holographic optical device which diffracts the light beam reflected from the information recording medium; and a photoreceptor which receives the light beam diffracted by the holographic optical device, the photoreceptor includes at least: a first photoreception region in which a first signal S1 is detected; a second photoreception region in which a second signal S2 is detected; a third photoreception region in which a third signal S3 is detected; and a fourth photoreception region in which a fourth signal S4 is detected, the first photoreception region and the second photoreception region face each other across a first photoreception dividing line, the third photoreception region and the fourth photoreception region face each other across a second photoreception dividing line, the holographic optical device includes a first diffraction region and a second diffraction region, the first diffraction region and the second diffraction region face each other across a region dividing line passing through an optical axis of the light-collection optical system and extending in a radial direction of the information recording medium, the signal detection method includes: generating, in the first diffraction region, diffracted light having a first wavefront and entering the first and second photoreception regions; and generating, in the second diffraction region, diffracted light having a second wavefront and entering the third and fourth photoreception regions, the first wavefront has a first coma aberration in the radial direction of the information recording medium, the first coma aberration having an axis located off the optical axis of the light-collection optical system, and the second wavefront has a second coma aberration in the radial direction of the information recording medium, the second coma aberration having an axis located off the optical axis of the light-collection optical system.

In addition, the present invention can be realized also as an optical information processing apparatus including: the optical head apparatus above; and a circuit which performs focus servo using a focus error signal generated by calculating (S1−S2) or (S3−S4), or both (S1−S2) and (S3−S4), where (S1−S2) is a difference between the first signal S1 and the second signal S2 and (S3−S4) is a difference between the third signal S3 and the fourth signal S4.

### Advantageous Effects of Invention

With the optical head apparatus and so on according to an implementation of the present invention, it is possible to reduce the adverse effect of a positional shift of the photoreceptor on tracking signals and to detect tracking error signals for more accurate and stable recording and/or reproduction.

### BRIEF DESCRIPTION OF DRAWINGS

FIG. 1 is a diagram showing a structure of an optical head apparatus according to Embodiment 1 of the present invention.

FIG. 2 is a plan view showing a holographic optical device of Embodiment 1 of the present invention.

FIG. 3 is a plan view showing a photoreceptor of Embodiment 1 of the present invention.

FIG. 4 is a diagram showing calculations of Embodiment 1 of the present invention.

[FIG. 5] The parts (a) to (e) in FIG. 5 are spot diagrams of Embodiment 1 of the present invention.

FIG. 6 is a graph showing focus error signals of Embodiment 1 of the present invention.

FIG. 7 is a diagram showing a structure of an optical head apparatus according to Embodiment 2 of the present invention.

FIG. 8 is a plan view showing a photoreceptor of Embodiment 2 of the present invention.

FIG. 9 is a structural diagram of an optical information processing apparatus of Embodiment 3 of the present invention.

FIG. 10 is a diagram showing a structure of an optical head apparatus according to Patent Literature 2.

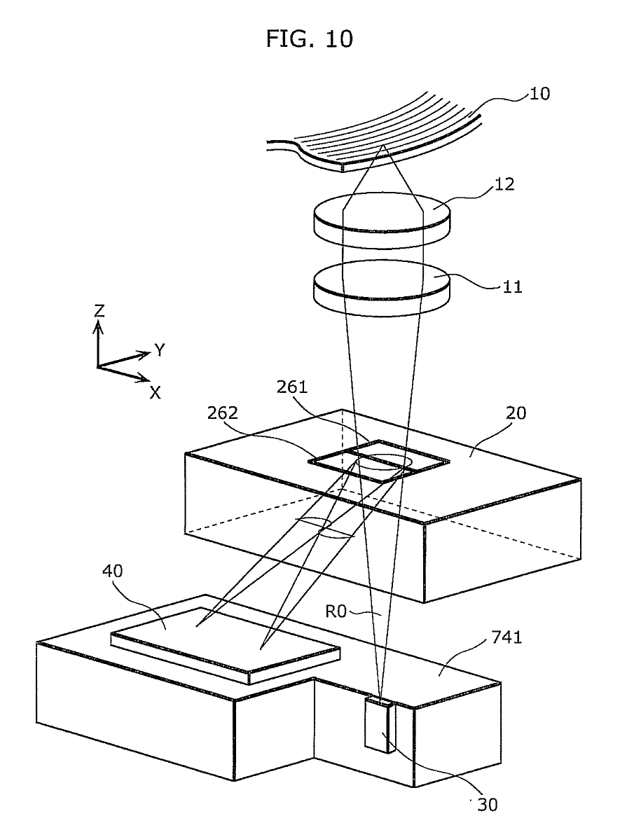

FIG. 11 is a plan view showing a holographic optical device of an optical head apparatus according to Patent Literature 2.

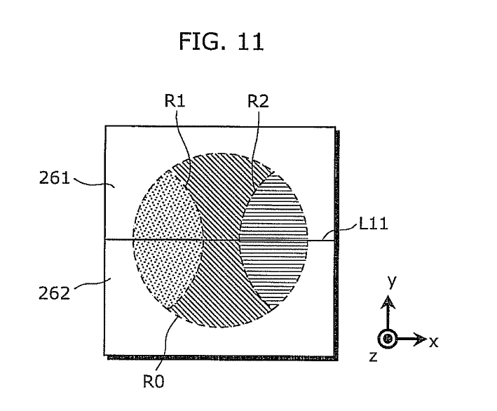

FIG. 12 is a plan view showing a photoreceptor of an optical head apparatus according to Patent Literature 2.

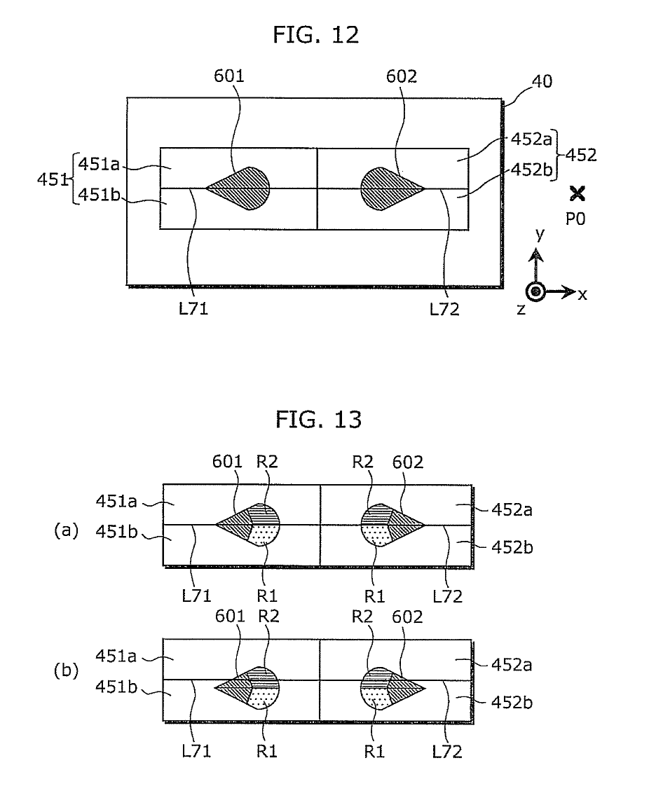

[FIG. 13] The parts (a) and (b) in FIG. 13 show states of light spots on a photoreceptor of an optical head apparatus according to Patent Literature 2.

### DESCRIPTION OF EMBODIMENTS

Hereinafter, an optical head apparatus, a holographic optical device, an optical integrated device, an optical information processing apparatus, and a signal detection method according to an implementation of the present invention are described in detail with reference to the drawings.

### Embodiment 1

First, the optical head apparatus according to Embodiment 1 of the present invention is described.

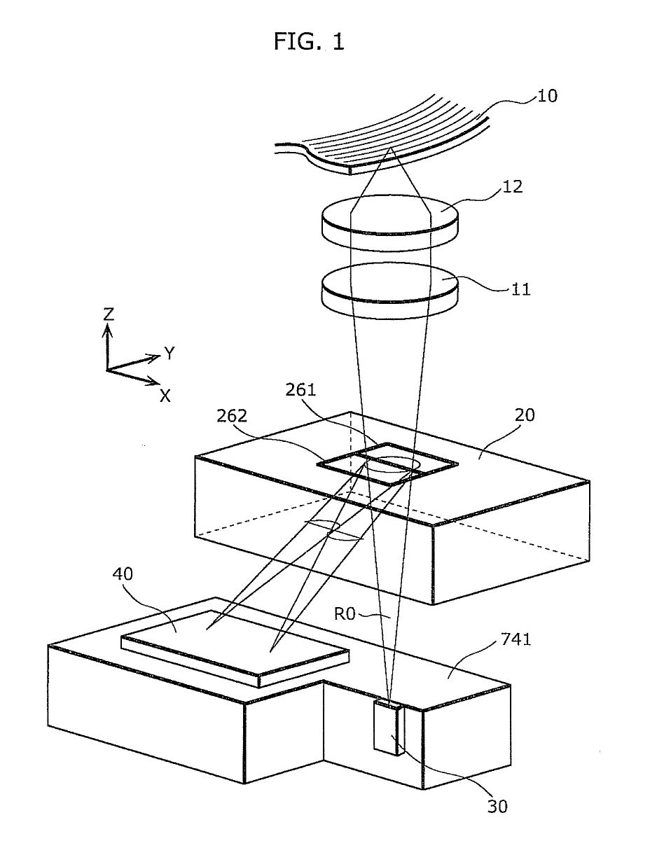

FIG. 1 is a schematic diagram showing a structure of the optical head apparatus according to Embodiment 1 of the present invention.

The optical head apparatus includes: a semiconductor laser device 30 which emits a light beam; a light-collection optical system (a collimating lens 11 and an object lens 12) which receives the light beam and converges the light beam to a minute spot on an optical disc 10 having tracks (information recording medium); a holographic optical device 20 which diffracts the light beam reflected from the optical disc 10; and a photoreceptor 40 which receives the light diffracted by the holographic optical device.

The semiconductor laser device 30 and the photoreceptor 40 are provided close to each other and fixed to a holding unit 741. The holding unit 741 is fixed with the holographic optical device 20 with a desired positional relationship via another holding unit (not shown). Note that although the holding unit 741 may be an optical bench of the optical head apparatus, a more stable optical system can be provided by integrating the semiconductor laser device 30 and the photoreceptor 40 into an optical integrated device by using a holding member different from the optical bench. In addition, further stabilization can be achieved by integrating the semiconductor laser device 30, the photoreceptor 40, and the holographic optical device 20 into an optical integrated device.

The collimating lens 11 and the object lens 12 make up a light-collection optical system for collecting laser light on the optical disc 10 that is an information recording medium. The optical head apparatus further includes a lens driving mechanism (not shown) that displaces the object lens 12 in the optical-axis direction of the object lens 12 (z direction) and in the radial direction of the optical disc 10 (x direction).

Hereinafter, unless otherwise noted, the optical-axis direction of the light-collection optical system is referred to as Z-axis direction, the radius direction of the optical disc 10 (radial direction) is referred to as X direction, and the track direction of the optical disc 10 (tangential direction) is referred to as Y direction as indicated in FIG. 1. Note that even in the case where the optical axis is bent by a mirror, a prism, or the like, the directions of the optical system of the optical head apparatus are defined with reference to the optical axis and a map of the optical disc 10.

First, a light beam emitted from the semiconductor laser device 30 of the optical head apparatus of Embodiment 1 is described. A light beam R0 emitted from the semiconductor laser device 30 passes through the holographic optical device 20 and is collected on the information recording surface of the optical disc 10 by the collimating lens 11 and the object lens 12. The light reflected from the optical disc 10 is converted by the object lens 12 and the collimating lens 11 into light converging at the light emission point of the semiconductor laser device 30. This light enters the holographic optical device 20 and is diffracted. The diffracted light enters the photoreceptor 40, and the photoreceptor 40 detects signals from the diffracted light.

The following is a description of the details on diffraction regions formed on the holographic optical device 20 and photoreception regions formed on the photoreceptor 40.

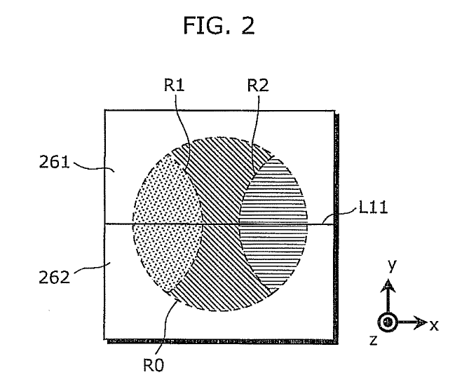

FIG. 2 is a diagram showing the diffraction regions of the holographic optical device 20 according to the present embodiment.

The grating pattern of the holographic optical device 20 is that it is divided into a first diffraction region 261 and a second diffraction region 262 by a straight line (region dividing line) L11 parallel to the X axis and passing through the approximate center of the light beam. R0 in FIG. 2 is the light reflected from the optical disc 10 and entering the holographic optical device 20. R1 and R2 are light diffracted by the optical disc 10, and produce a contrast corresponding to a tracking position in regions interfering with R0, that is, overlapping regions. FIG. 2 separately shows a region that the light beams R0 and R1 both enter (hereinafter referred to as region R1), a region that the light beams R0 and R2 both enter (hereinafter referred to as region R2), and a region that only the light beam R0 enters (hereinafter referred to as region R0).

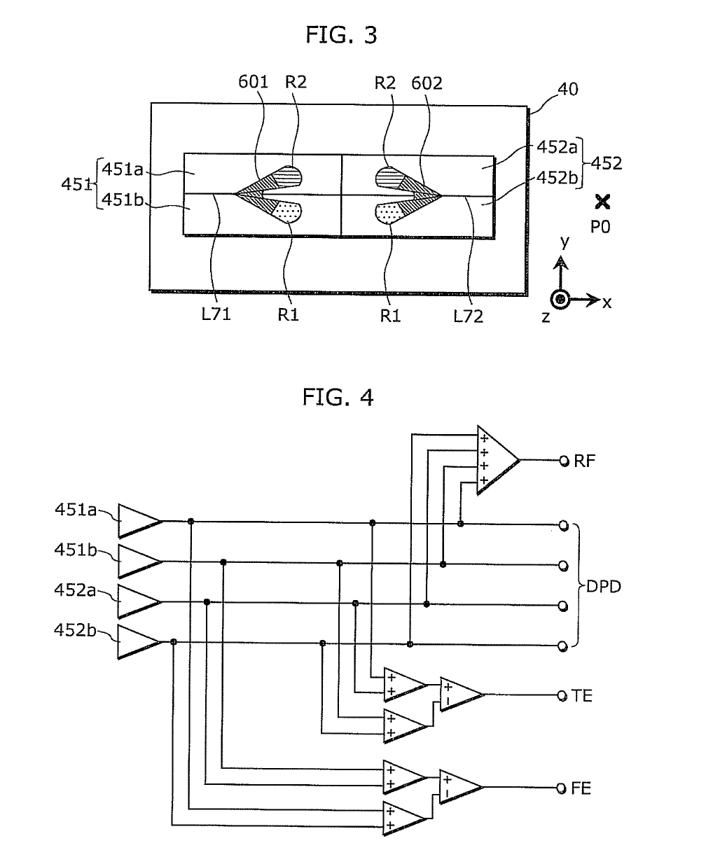

FIG. 3 is a diagram showing photoreception regions of the photoreceptor 40 according to the present embodiment. The photoreceptor 40 has a first photoreception region group 451 and a second photoreception region group 452. The first photoreception region group 451 includes a first photoreception region 451a and a second photoreception region 451b facing each other across a first photoreception dividing line L71 which is approximately parallel to the X axis. The second photoreception region group 452 includes a third photoreception region 452a and a fourth photoreception region 452b facing each other across a second photoreception dividing line L72 which is approximately parallel to the X axis.

The first diffraction region 261 has a grating pattern that converts light returning from the optical disc 10 into light having a first wavefront and entering the first photoreception region 451a and the second photoreception region 451b with a first coma aberration in the X direction across the first photoreception dividing line L71 of the first photoreception region group 451. Note that the center of the first coma aberration is at a position shifted in the tangential direction (Y direction) from the optical axis.

The second diffraction region 262 has a grating pattern that converts light returning from the optical disc 10 into light having a second wavefront and entering the third photoreception region 452a and the fourth photoreception region 452b with a second coma aberration which is formed across the second photoreception dividing line L72 of the second photoreception region group 452 and is opposite in polarity to the first coma aberration caused by the grating pattern of the first diffraction region 261. Note that as in the first diffraction region 261, the center of the second coma aberration is at a position shifted in the tangential direction (Y direction) from the optical axis.

Here, the light has the second coma aberration which is opposite in polarity to the first coma aberration caused by the grating pattern of the first diffraction region 261, for the purpose of separating a tracking signal and a focus signal which are to be described later.

In addition, there is also an advantageous effect of canceling out the offset of a focus error signal generated due to a Y-directional shift of the photoreceptor, by reversing the sign of a later-described calculation performed for generating a focus error signal using the first photoreception region 451a and the third photoreception region 452a as well as the second photoreception region 451b and the fourth photoreception region 452b.

In FIG. 3, a spot 601 indicates light diffracted by the first diffraction region 261 and a spot 602 indicates light diffracted by the second diffraction region 262. The spots 601 and 602 distinguishably show the light diffracted by each of the regions R0, R1, and R2, using the same shading patterns as in FIG. 2.

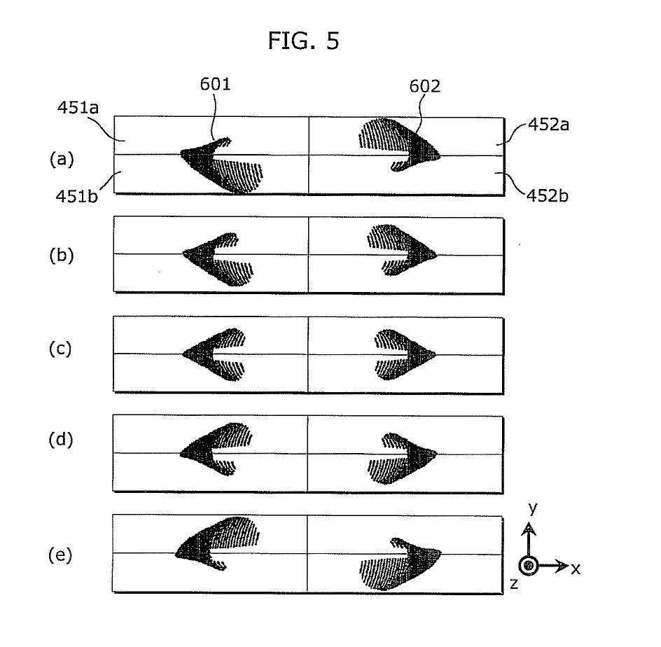

The signals from the photoreception regions undergo processing by a calculation circuit shown in FIG. 4 so that a focus error signal (FE signal) and a tracking error signal (TE signal) are detected.

First, the principle of the focus error signal detection is described.

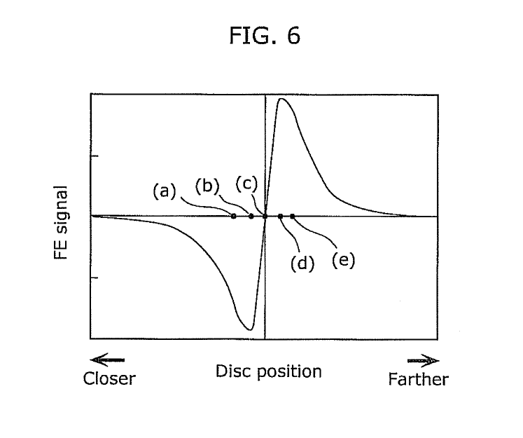

The parts (a) to (e) of FIG. 5 are spot diagrams showing light spots on the photoreceptor 40, and FIG. 6 is a graph showing focus error signals obtained.

The parts (a) to (e) of FIG. 5 are spot diagrams each corresponding to one of positions (a) to (e) of the optical disc 10 that are indicated in FIG. 6. Note that in FIG. 6, the origin point is set to a disc position at which a focused state is reached, that is, the smallest spot is formed on the information recording surface of the optical disc 10 ((c) in FIGS. 5 and 6).

As previously described, the FE signal is detected by the circuit shown in FIG. 4. Here, the following assumptions are applied: a signal detected in the first photoreception region 451a is a first signal S1; a signal detected in the second photoreception region 451b is a second signal S2; a signal detected in the third photoreception region 452a is a third signal S3; a signal detected in the fourth photoreception region 452b is a fourth signal S4; a sum of the first signal S1 and the fourth signal S4 is (S1+S4); and a sum of the second signal S2 and the third signal S3 is (S2+S3). With such assumptions, one of the calculations performed by this circuit can be expressed as Equation 4 below.

FE=(S1+S4)−(S2+S3) (Equation 4)

First, in the focused state ((c) in FIGS. 5 and 6), the second signal S2 (signal detected in the second photoreception region 451b), and the first signal S1 (signal detected in the first photoreception region 451a) are in balance and the third signal S3 (signal detected in the third photoreception region 452a) and the fourth signal S4 (signal detected in the fourth photoreception region 452b) are also in balance, making the focus error signal FE in Equation 4 zero.

When the optical disc 10 gets closer to the object lens 12 than it is in the focused state ((b) in FIGS. 5 and 6), the spot 601 moves from the first photoreception region 451a toward the second photoreception region 451b accordingly. Likewise, the spot 602 moves from the fourth photoreception region 452b toward the third photoreception region 452a. As a result, the focus error signal FE in Equation 4 above has a negative value.

When the optical disc 10 gets further closer to the object lens 12, the spot 601 moves almost entirely to the second photoreception region 451b, and the spot 602 moves almost entirely to the third photoreception region 452a as shown in (a) in FIGS. 5 and 6. In this state, the focus error signal FE has a minimum value.

On the other hand, when the optical disc 10 gets farther from the object lens 12 than it is in the focused state ((d) in FIGS. 5 and 6), the spot 601 moves from the second photoreception region 451b toward the first photoreception region 451a accordingly. Likewise, the spot 602 moves from the third photoreception region 452a toward the fourth photoreception region 452b. As a result, the focus error signal FE in Equation 4 above has a positive value. When the optical disc 10 gets even farther from the object lens 12, the spot 601 moves almost entirely to the first photoreception region 451a, and the spot 602 moves almost entirely to the fourth photoreception region 452b as shown in (e) in FIGS. 5 and 6. In this state, the focus error signal FE has a maximum value.

In such a manner, the focus error signal FE that varies according to the position of the optical disc 10 can be obtained.

Note that the distance between the position at which the focus error signal FE has the maximum value and the position at which the focus error signal FE has the minimum value, that is, the range in which the focus error signal is detected, can be designed as desired through adjustment of the amounts of the first and second coma aberrations of the light generated by the holographic optical device 20.

Next, the principle of the tracking error signal detection is described with reference to FIG. 3.

Here, assuming that a sum of the first signal S1 and the third signal S3 is (S1+S3) and a sum of the second signal S2 and the fourth signal S4 is (S2+S4), a tracking error signal TE_{PP} according to the push-pull method and a tracking error signal TE_{DPD} according to the DPD method are generated by calculation according to the equations below.

TE_{PP}=(S1+S3)−(S2+S4) (Equation 5)

TE_{DPD}=Phase (S1+S4, S2+S3) (Equation 6)

Here, phase is a function for phase comparison (calculation of phase difference) between two signals.

Equation 5 above represents a differential between the interference region of the light beams R0 and R1 and the interference region of the light beams R0 and R2, and thus allows detection of the push-pull signal equivalent to that disclosed in the technique according to Patent Literature 2.

Equation 6 above compares the phases of the sums of diagonally opposite signals, and thus allows detection of a signal equivalent to the differential phase detection tracking error signal disclosed in the technique according to Patent Literature 2.

A feature of the optical head apparatus of the present embodiment is that the light containing the tracking signal components and passing through the regions R1 and R2 enters a position located off the first photoreception dividing line L71 and the second photoreception dividing line L72. This is achieved by having the centers of the above-described first and second coma aberrations shifted in the tangential direction (Y direction). This makes it possible, even when the photoreceptor 40 is shifted in the tangential direction (Y direction), to provide an optical head apparatus capable of reliably extracting the tracking signal components and less susceptible to an error in adjusting the photoreceptor 40.

As described thus far, according to Embodiment 1, it is possible to detect a tracking error signal in a manner less susceptible to a shift of the photoreceptor 40 in the tangential direction (Y direction) caused by an adjustment error, for example.

Note that although what is described above is the structure in which the centers of the first and second coma aberrations are shifted only in the tangential direction (Y direction), the present invention is not limited to this. Any structure is acceptable as long as the centers of the first and second coma aberrations are located off a straight line passing through the optical axis and extending in the radial direction, that is, as long as the positional vectors of the first and second coma aberrations have a Y-directional component.

### Embodiment 2

Next, the optical head apparatus according to Embodiment 2 of the present invention is described.

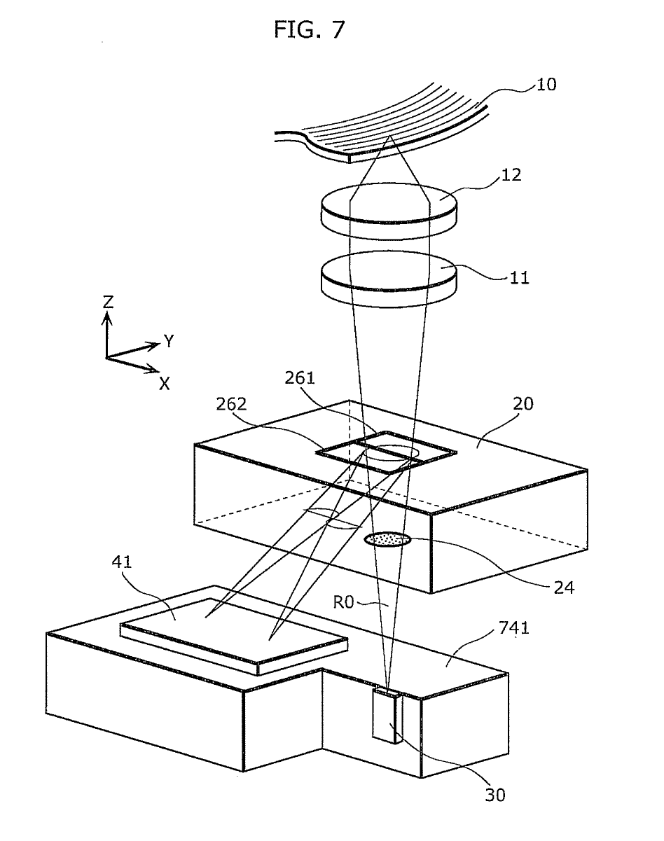

FIG. 7 is a schematic diagram showing a structure of the optical head apparatus according to Embodiment 2 of the present invention.

FIG. 7 shows a semiconductor laser device 30, a photoreceptor 41, a holographic optical device 20, and others. A diffraction grating 24 is formed on a surface of the holographic optical device 20 closer to the semiconductor laser device 30. The semiconductor laser device 30 and the photoreceptor 41 are provided close to each other and fixed to a holding unit 741. The holding unit 741 is fixed with the holographic optical device 20 with a desired positional relationship via another holding unit (not shown). Note that although the other holding unit may be an optical bench of the optical head apparatus, a unit (an optical integrated device, for example) may be provided into which the holographic optical device 20, the semiconductor laser device 30, and the photoreceptor 41 are integrated using a holding member different from the optical bench. Such a unit structure allows the optical system to be stably structured.

The optical head apparatus further includes a collimating lens 11 and an object lens 12 that make up a light-collection optical system for collecting laser light on an optical disc 10 that is an information recording medium. In addition, the optical head apparatus includes a lens driving mechanism (not shown) that displaces the object lens 12 in the optical-axis direction of the object lens 12 (z direction) and in the radial direction of the optical disc 10 (x direction).

First, a light beam emitted from the semiconductor laser device 30 of the optical head apparatus of Embodiment 2 is described. A light beam R0 emitted from the semiconductor laser device 30 is separated into a main beam (R0a) that is zero-order light and two sub beams R0b and R0c that are ± first-order light (not shown) through diffraction at a desired ratio by the diffraction grating 24. These beams pass through the holographic optical device 20 and are collected on the information recording surface of the optical disc 10 by the collimating lens 11 and the object lens 12. The light reflected from the optical disk 10 is converted by the object lens 12 and the collimating lens 11 into light converging at the light emission point of the semiconductor laser device 30. This light enters the holographic optical device 20 and is diffracted. The diffracted light enters the photoreceptor 41, and the photoreceptor 41 detects signals from the diffracted light. Here, the region of the diffraction grating 24 is set to an appropriate size such that the light diffracted by the holographic optical device 20 is not diffracted.

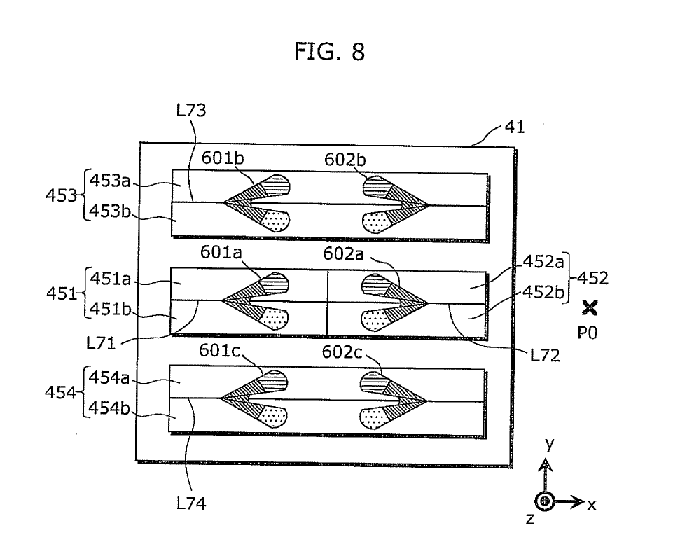

As with the holographic optical device described in Embodiment 1, the holographic optical device 20 has the same first diffraction region 261 and the same second diffraction region 262 as those in FIG. 2, and these diffraction regions have the same grating patterns as those in FIG. 2. The structure of the photoreceptor 41 is like that shown in FIG. 8.

The photoreceptor 41 has a first photoreception region group 451 and a second photoreception region group 452. The first photoreception region group 451 includes a first photoreception region 451a and a second photoreception region 451b facing each other across a first photoreception dividing line L71 which is approximately parallel to the X axis. The second photoreception region group 452 includes a third photoreception region 452a and a fourth photoreception region 452b facing each other across a second photoreception dividing line L72 which is approximately parallel to the X axis.

The photoreceptor 41 also has a third photoreception region group 453 and a fourth photoreception region group 454 on the Y-directional sides of the first photoreception region group 451 and the second photoreception region group 452.

The third photoreception region group 453 includes a fifth photoreception region 453a and a sixth photoreception region 453b facing each other across a third photoreception dividing line L73 which is approximately parallel to the X axis.

The fourth photoreception region group 454 includes a seventh photoreception region 454a and an eighth photoreception region 454b facing each other across a fourth photoreception dividing line L74 which is approximately parallel to the X axis.

The previously-described first diffraction region 261 has a grating pattern that forms a spot 601a through which the main beam (R0a), which is part of the light returning from the optical disc 10, enters the first photoreception region 451a and the second photoreception region 451b with a first coma aberration in the x direction across the first photoreception dividing line L71 of the first photoreception region group 451.

At this time, the light on the positive side of the X axis in FIG. 2 is detected in the second photoreception region 451b, whereas the light on the negative side is detected in the first photoreception region 451a. With this, a tracking error signal can be detected according to the push-pull method.

Furthermore, the second diffraction region 262 has a grating pattern that forms a spot 602a through which the main beam (R0a), which is part of the light returning from the optical disc 10, enters the third photoreception region 452a and the fourth photoreception region 452b with a second coma aberration which is formed across the second photoreception dividing line L72 of the second photoreception region group 452 and is opposite in polarity to the first coma aberration caused by the grating pattern of the first diffraction region 261.

At this time, the light on the positive side of the X axis in FIG. 2 is detected in the third photoreception region 452a, whereas the light on the negative side is detected in the fourth photoreception region 452b. With this, a tracking error signal can be detected according to the push-pull method.

The sub beam R0b enters positions spanning the third photoreception dividing line L73. More specifically, the light diffracted in the first diffraction region 261 enters a spot 601b, and the light diffracted in the second diffraction region 262 enters a spot 602b. Furthermore, the sub beam R0c enters positions spanning the fourth photoreception dividing line L74. More specifically, the light diffracted in the first diffraction region 261 enters a spot 601c, and the light diffracted in the second diffraction region 262 enters a spot 602c.

Like from the main beam, the tracking error signal can be detected according to the push-pull method also from the sub beams using signals detected in the two detection regions that the light from the corresponding spots enters.

With the optical head apparatus of the present embodiment, a focus error signal is detected using a later-described detection method according to an implementation of the present invention, and a tracking error signal TE_{DPD} according to the DPD method and a tracking error signal TE_{DPP} according to the DPP method are generated by calculation according to the equations below.

FE=(S1+S4)−(S2+S3) (Equation 7)

TE_{DPP}=TE_{MPP}−K·TE_{SPP} (Equation 8)

TE_{DPD}=phase (S2, S1)−phase (S3, S4) (Equation 9)

Here, the following assumptions are applied: a signal detected in the fifth photoreception region 453a is a fifth signal S5; a signal detected in the sixth photoreception region 453b is a sixth signal S6; a signal detected in the seventh photoreception region 454a is a seventh signal S7; a signal detected in the eighth photoreception region 454b is an eighth signal S8; a sum of the fifth signal S5 and the seventh signal S7 is (S5+S7); and a sum of the sixth signal S6 and the eighth signal S8 is (S6+S8). With such assumptions, TE_{MPP} which is a push-pull signal of the main beam and TE_{SPP} which is a push-pull signal of the sub beams can be given according to the equations below.

TE_{MPP}=(S1+S3)−(S2+S4) (Equation 10)

TE_{SPP}=(S5+S7)−(S6+S8) (Equation 11)

K is a constant optimized so that fluctuations of TE_{MPP} caused by a shift of the object lens 12 are minimized.

Furthermore, a signal RF for reading recorded information is also generated.

A feature of the optical head apparatus of the present embodiment, too, is that the light containing the tracking signal components and passing through the regions R1 and R2 enters a position located off the first photoreception dividing line L71 and the second photoreception dividing line L72.

This is achieved by having the centers of the above-described first and second coma aberrations shifted in the tangential direction (Y direction). This makes it possible, even when the photoreceptor 41 is shifted in the tangential direction (Y direction), to provide an optical head apparatus capable of reliably extracting the tracking signal components and less susceptible to an error in adjusting the photoreceptor 41.

In addition, with the optical head apparatus of the present embodiment, the light of the sub beams passing through the regions R1 and R2 enters positions located off the third photoreception dividing line L73 and the fourth photoreception dividing line L74. This makes it possible to accept not only the shift of the photoreceptor 41 in the Y direction but also a change in the distance between the sub beams caused by such factors as a change in the wavelength of the semiconductor laser device 30 and a shift of the diffraction grating 24 in the optical-axis direction.

As described thus far, according to Embodiment 2, it is possible to detect a tracking error signal in a manner that is less susceptible to a change in the distance between the sub beams and a shift of the photoreceptor 41 in the tangential direction (Y direction) caused by an adjustment error, for example.

Note that although what is described above is the structure in which the centers of the first and second coma aberrations are shifted only in the tangential direction (Y direction), the present invention is not limited to this. Any structure is acceptable as long as the centers of the first and second coma aberrations are located off a straight line passing through the optical axis and extending in the radial direction, that is, as long as the positional vectors of the first and second coma aberrations have a Y-directional component.

### Embodiment 3

Next, the optical information processing apparatus (optical disc apparatus) of Embodiment 3 of the present invention is described.

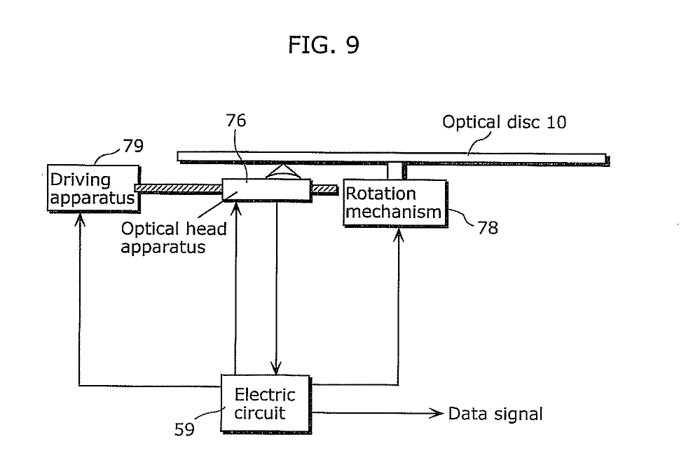

FIG. 9 is a diagram showing a structure of the optical information processing apparatus of Embodiment 3 of the present invention. The optical information processing apparatus includes an optical disc 10, an electric circuit 59, an optical head apparatus 76, a driving apparatus 79, and a rotation mechanism 78.

The rotation mechanism 78 is a mechanism that holds and rotates the optical disc 10. The optical head apparatus 76 is the optical head apparatus of either Embodiment 1 or Embodiment 2 and includes a unit for finely adjusting the object lens 12. The optical head apparatus 76 is coarsely adjusted by the driving apparatus 79 to a track of the optical disc 10 where desired information is recorded. The optical head apparatus 76 then sends a signal to the driving apparatus 79. The electric circuit 59 has all or some of the calculation functions shown in FIG. 4 and generates a TE signal and an FE signal. Based on these signals, the electric circuit 59 sends a signal for finely adjusting the optical head apparatus 76 and the object lens 12, and performs focus servo and tracking servo.

A reproduction signal is generated as a sum of signals detected by the photoreceptor 40 in either the optical head apparatus 76 or the electric circuit 59, and is output as a data raw signal after undergoing signal processing such as processing by an equalizer.

With the optical information processing apparatus of the present embodiment, the tracking error signal can be stably detected even when the photoreceptor 40 of the optical head apparatus 76 is shifted, and thus tracking servo can be stably performed, enabling favorable recording and reproduction.

Although the optical head apparatus, the holographic optical device, the optical integrated device, the optical information processing apparatus, and the signal detection method according to an implementation of the present invention have been described above based on Embodiments 1 to 3, the present invention is not limited to such embodiments. The scope of the present invention also includes what a person skilled in the art can conceive without departing from the scope of the present invention; for example, implementations realized by making various modifications to the above embodiments and implementations realized by arbitrarily combining the constituent elements of the embodiments.

### INDUSTRIAL APPLICABILITY

The optical head apparatus, the holographic optical device, the optical integrated device, the optical information processing apparatus, and the signal detection method according to the present invention can be used for recording information on an information storage medium and reproducing the recorded information, and are useful as video/audio recording and reproduction apparatuses and so on. In addition, they can also be applied for storing data and programs of a computer, storing map data of a car navigation system, and so on.

### REFERENCE SIGNS LIST

10 Optical disc

11 Collimating lens

12 Object lens

20 Holographic optical device

24 Diffraction grating

30 Semiconductor laser device

40 Photoreceptor

41 Photoreceptor

59 Electric circuit

76 Optical head apparatus

78 Rotation mechanism

79 Driving apparatus

1. An optical head apparatus comprising:
a light source which emits a light beam;
a light-collection optical system which receives the light beam and converges the light beam to a minute spot on an information recording medium having tracks;
a holographic optical device which diffracts the light beam reflected from the information recording medium; and
a photoreceptor which receives the light beam diffracted by said holographic optical device,
wherein said photoreceptor includes at least:
a first photoreception region in which a first signal S1 is detected;
a second photoreception region in which a second signal S2 is detected;
a third photoreception region in which third signal S3 is detected; and
a fourth photoreception region in which a fourth signal 54 is detected,
said first photoreception region and said second photoreception region face each other across a first photoreception dividing line,
said third photoreception region and said fourth photoreception region face each other across a second photoreception dividing line,
said holographic optical device includes a first diffraction region and a second diffraction region,
said first diffraction region and said second diffraction region face each other across a region dividing line passing through an optical axis of said light-collection optical system and extending in a radial direction of the information recording medium,
said first diffraction region has a grating pattern for generating diffracted light having a first wavefront and entering said first and second photoreception regions,
said second diffraction region has a grating pattern for generating diffracted light having a second wavefront and entering said third and fourth photoreception regions,
the first wavefront has a first coma aberration in the radial direction of the information recording medium, the first coma aberration having an axis located off the optical axis of said light-collection optical system, and
the second wavefront has a second coma aberration in the radial direction of the information recording medium, the second coma aberration having an axis located off the optical axis of said light-collection optical system.

2. The optical head apparatus according to claim 1, further comprising
a circuit which detects a focus error signal FE by calculating (S1−S2) or (S3−S4), or both (S1−S2) and (S3−S4),
where (S1−S2) is a difference between the first signal S1 and the second signal S2 and (S3−S4) is a difference between the third signal S3 and the fourth signal S4.

3. The optical head apparatus according to claim 2,
wherein the first coma aberration and the second coma aberration have opposite polarities.

4. The optical head apparatus according to claim 3, further comprising
a circuit which detects the focus error signal by calculating (S1+S4)−(S2+S3),
where (S1+S4) is a sum of the first signal S1 and the fourth signal S4 and (S2+S3) is a sum of the second signal S2 and the third signal S3.

5. The optical head apparatus according to claim 1, further comprising
a circuit which detects a push-pull signal by calculating (S1+S3)−(S2+S4),
where (S1+S3) is a sum of the first signal S1 and the third signal S3 and (S2+S4) is a sum of the second signal S2 and the fourth signal S4.

6. The optical head apparatus according to claim 1, further comprising
a circuit which detects a signal indicating a phase difference between a signal (S1+S4) and a signal (S2+S3),
where (S1+S4) is a sum of the first signal S1 and the fourth signal S4 and (S2+S3) is a sum of the second signal S2 and the third signal S3.

7. The optical head apparatus according to claim 1, further comprising
a diffraction grating for generating a main beam, a first sub beam, and a second sub beam from the light beam emitted from said light source,
wherein said photoreceptor further includes:
a fifth photoreception region in which a fifth signal S5 is detected;
a sixth photoreception region in which a sixth signal S6 is detected;
a seventh photoreception region in which a seventh signal S7 is detected; and
an eighth photoreception region in which an eighth signal S8 is detected,
said fifth photoreception region and said sixth photoreception region face each other across a third photoreception dividing line, and
said seventh photoreception region and said eighth photoreception region face each other across a fourth photoreception dividing line.

8. The optical head apparatus according to claim 7, further comprising
a circuit which detects a differential push-pull signal by calculating {(S1+S3)−(S2+S4)}−K{(S5+S7)−(S6+S8)},
where K is a constant, (S1+S3) is a sum of the first signal S1 and the third signal S3, (S2+S4) is a sum of the second signal S2 and the fourth signal S4, (S5 +S7) is a sum of the fifth signal S5 and the seventh signal S7, and (S6+S8) is a sum of the sixth signal S6 and the eighth signal S8.

9. A holographic optical device which functions as a diffraction device that diffracts light, said holographic optical device comprising
a first diffraction region and a second diffraction region facing each other across a region dividing line,
wherein said first diffraction region generates diffracted light having a first coma aberration in a direction of the region dividing line, the first coma aberration having an axis located off the region dividing line and
said second diffraction region generates diffracted light having a second coma aberration in the direction of the region dividing line, the second coma aberration having an axis located off the region dividing line.

10. The holographic optical device according to claim 9,
wherein the first coma aberration and the second coma aberration have opposite polarities.

11. An optical integrated device comprising:
a light source which emits a light beam;
a holographic optical device which diffracts the light beam reflected from an information recording medium; and
a photoreceptor which receives the light beam diffracted by said holographic optical device,
wherein said photoreceptor includes at least:
a first photoreception region in which a first signal S1 is detected;
a second photoreception region in which a second signal S2 is detected;
a third photoreception region in which a third signal S3 is detected; and
a fourth photoreception region in which a fourth signal S4 is detected,
said first photoreception region and said second photoreception region face each other across a first photoreception dividing line,
said third photoreception region and said fourth photoreception region face each other across a second photoreception dividing line,
said holographic optical device includes a first diffraction region and a second diffraction region,
said first diffraction region and said second diffraction region face each other across a region dividing line passing through an optical axis of a light-collection optical system and extending in a radial direction of the information recording medium,
said first diffraction region has a grating pattern for generating diffracted light having a first wavefront and entering said first and second photoreception regions,
said second diffraction region has a grating pattern for generating diffracted light having, a second wavefront and entering said third and fourth photoreception regions,
the first wavefront has a first coma aberration in the radial direction of the information recording medium, the first coma aberration having an axis located off the optical axis of the light-collection optical system, and
the second wavefront has a second coma aberration in the radial direction of the information recording medium, the second coma aberration having an axis located off the optical axis of the light-collection optical system.

12. The optical integrated device according to claim 11, further comprising
a circuit which detects a focus error signal FE by calculating (S1−S2) or (S3−S4), or both (S1−S2) and (S3−S4),
where (S1−S2) is a difference between the first signal S1 and the second signal S2 and (S3−S4) is a difference between the third signal S3 and the fourth signal S4.

13. The optical integrated device according to claim 12,
wherein the first coma aberration and the second coma aberration have opposite polarities.

14. The optical integrated device according to claim 13, further comprising
a circuit which detects the focus error signal by calculating (S1+S4)−(S2+S3),
where (S1+S4) is a sum of the first signal S1 and the fourth signal S4 and (S2+S3) is a sum of the second signal S2 and the third signal S3.

15. The optical integrated device according to claim 11, further comprising
a circuit which detects a push-pull signal by calculating (S1+S3)−(S2+S4),
where (S1+S3) is a sum of the first signal S1 and the third signal S3 and (S2 +S4) is a sum of the second signal S2 and the fourth signal S4.

16. The optical integrated device according to claim 11, further comprising
a circuit which detects a signal indicating a phase difference between a signal (S1+S4) and a signal (S2+S3),
where (S1+S4) is a sum of the first signal S1 and the fourth signal S4 and (S2+S3) is a sum of the second signal S2 and the third signal S3.

17. The optical integrated device according to claim 11, further comprising
a diffraction grating for generating a main beam, a first sub beam, and a second sub beam from the light beam emitted from said light source,
wherein said photoreceptor further includes:
a fifth photoreception region in which a fifth signal S5 is detected;
a sixth photoreception region in which a sixth signal S6 is detected;
a seventh photoreception region in which a seventh signal S7 is detected; and
an eighth photoreception region in which an eighth signal S8 is detected,
said fifth photoreception region and said sixth photoreception region face each other across a third photoreception dividing line, and
said seventh photoreception region and said eighth photoreception region face each other across a fourth photoreception dividing line.

18. The optical integrated device according to claim 17, further comprising
a circuit which detects a differential push-pull signal by calculating {(S1+S3)−(S2+S4)}−K{(S5+S7)−(S6+S8)},
where K is a constant, (S1+S3) is a sum of the first signal S1 and the third signal S3, (S2+S4) is a sum of the second signal S2 and the fourth signal S4, (S5+S7) is a sum of the fifth signal S5 and the seventh signal S7, and (S6+S8) is a sum of the sixth signal S6 and the eighth signal S8.

19. A signal detection method performed by an optical head apparatus,
wherein the optical head apparatus includes:
a light source which emits a light beam;
a light-collection optical system which receives the light beam and converges the light beam to a minute spot on an information recording medium having tracks;
a holographic optical device which diffracts the light beam reflected from the information recording medium; and
a photoreceptor which receives the light beam diffracted by the holographic optical device,
the photoreceptor includes at least:
a first photoreception region in which a first signal S1 is detected;
a second photoreception region in which a second signal S2 is detected;
a third photoreception region in which a third signal S3 is detected; and
a fourth photoreception region in which a fourth signal S4 is detected,
the first photoreception region and the second photoreception region face each other across a first photoreception dividing line,
the third photoreception region and the fourth photoreception region face each other across a second photoreception dividing line,
the holographic optical device includes a first diffraction region and a second diffraction region,
the first diffraction region and the second diffraction region face each other across a region dividing line passing through an optical axis of the light-collection optical system and extending in a radial direction of the information recording medium,
said signal detection method comprises:
generating, in the first diffraction region, diffracted light having a first wavefront and entering the first and second photoreception regions; and
generating, in the second diffraction region, diffracted light having a second wavefront and entering the third and fourth photoreception regions,
the first wavefront has a first coma aberration in the radial direction of the information recording medium, the first coma aberration having an axis located off the optical axis of the light-collection optical system, and
the second wavefront has a second coma aberration in the radial direction of the information recording medium, the second coma aberration having an axis located off the optical axis of the light-collection optical system.

20. The signal detection method according to claim 19, further comprising
detecting a focus error signal FE by calculating (S1−S2) or (S3−S4), or both (S1−S2) and (S3−S4),
where (S1−S2) is a difference between the first signal S1 and the second signal S2 and (S3−S4) is a difference between the third signal S3 and the fourth signal S4.

21. The signal detection method according to claim 20,
wherein the first coma aberration and the second coma aberration have opposite polarities.

22. The signal detection method according to claim 21, further comprising
detecting the focus error signal by calculating (S1+S4)−(S2+S3),
where (S1+S4) is a sum of the first signal S1 and the fourth signal S4 and (S2+S3) is a sum of the second signal S2 and the third signal S3.

23. The signal detection method according to claim 19, further comprising
detecting a push-pull signal by calculating (S1+S3)−(S2+S4),
where (S1+S3) is a sum of the first signal S1 and the third signal S3 and (S2+S4) is a sum of the second signal S2 and the fourth signal S4.

24. The signal detection method according to claim 19, further comprising
detecting a signal indicating a phase difference between a signal (S1+S4) and a signal (S2+S3),
where (S1+S4) is a sum of the first signal S1 and the fourth signal S4 and (S2+S3) is a sum of the second signal 52 and the third signal S3.

25. The signal detection method according to claim 19,
wherein the optical head apparatus further includes
a diffraction grating for generating a main beam, a first sub beam, and a second sub beam from the light beam emitted from the light source,
the photoreceptor further includes:
a fifth photoreception region in which a fifth signal S5 is detected;
a sixth photoreception region in which a sixth signal S6 is detected;
a seventh photoreception region in which a seventh signal S7 is detected; and
an eighth photoreception region in which an eighth signal S8 is detected,
the fifth photoreception region and the sixth photoreception region face each other across a third photoreception dividing line, and
the seventh photoreception region and the eighth photoreception region face each other across a fourth photoreception dividing line.

26. The signal detection method according to claim 25, further comprising
detecting a differential push-pull signal by calculating {(S1+S3)−(S2+S4)}K{(S5+S7)−(S6+S8)},
where K is a constant, (S1+S3) is a sum of the first signal S1 and the third signal S3, (S2+54) is a sum of the second signal S2 and the fourth signal S4, (S5+S7) is a sum of the fifth signal S5 and the seventh signal S7, and (S6+S8) is a sum of the sixth signal S6 and so the eighth signal S8.

27. An optical information processing apparatus comprising:
said optical head apparatus according to claim 1; and
a circuit which performs focus servo using a focus error signal generated by calculating (S1−S2) or (S3−S4), or both (S1−S2) and (S3−S4),
where (S1−S2) is a difference between the first signal S1 and the second signal S2 and (S3−S4) is a difference between the third signal S3 and the fourth signal S4.

28. The optical information processing apparatus according to claim 27,
wherein the first coma aberration and the second coma aberration have opposite polarities.

29. The optical information processing apparatus according to claim 28, further comprising
a circuit which detects the focus error signal by calculating (S1+S4)−(S2+S3),
where (S1+S4) is a sum of the first signal S1 and the fourth signal S4 and (S2+S3) is a sum of the second signal S2 and the third signal S3.

30. The optical information processing apparatus according to claim 27, further comprising
a circuit which detects a push-pull signal by calculating (S1+S3)−(S2+S4),
where (S1+S3) is a sum of the first signal S1 and the third signal S3 and (S2+S4) is a sum of the second signal S2 and the fourth signal S4.

31. The optical information processing apparatus according to claim 27, further comprising
a circuit which detects a signal indicating a phase difference between a signal (S1+S4) and a signal (S2+S3),
where (S1+S4) is a sum of the first signal S1 and the fourth signal S4 and (S2+S3) is a sum of the second signal S2 and the third signal S3.

32. The optical information processing apparatus according to claim 27, further comprising
a diffraction grating for generating a main beam, a first sub beam, and a second sub beam from the light beam emitted from said light source,
wherein said photoreceptor further includes:
a fifth photoreception region in which a fifth signal S5 is detected;
a sixth photoreception region in which a sixth signal S6 is detected;
a seventh photoreception region in which a seventh signal S7 is detected; and
an eighth photoreception region in which an eighth signal 58 is detected,
said fifth photoreception region and said sixth photoreception region face each other across a third photoreception dividing line, and
said seventh photoreception region and said eighth photoreception region face each other across a fourth photoreception dividing line.

33. The optical information processing apparatus according to claim 32, further comprising
a circuit which detects a differential push-pull signal by calculating {(S1+S3)−(S2+S4)}K{(S5+S7)−(S6+S8)},
where K is a constant, (S1+S3) is a sum of the first signal S1 and the third signal S3, (S2+S4) is a sum of the second signal S2 and the fourth signal S4, (S5+S7) is a sum of the fifth signal S5 and the seventh signal S7, and (S6+S8) is a sum of the sixth signal S6 and the eighth signal S8.
